(19) United States
(12) Patent Application Publication
(10) Pub. No.: US 2001/0052262 A1
(43) Pub. Date: Dec. 20, 2001

(54) Mass flowmeter

(76) Inventor: Stephen Setescak, Pentling (DE)

Correspondence Address: LERNER AND GREENBERG, P.A., Post Office Box 2480, Hollywood, FL, 33022-2480, US

(21) Appl. No.: 09/874,777

(22) Filed: Jun. 5, 2001

(30) Foreign Application Priority Data
Jun. 5, 2000 (DE) 100 27 830.2

(51) Int. Cl. G01F 1/68

(52) U.S. Cl. 73/204.21

(57) ABSTRACT

A mass flowmeter includes a sensor element and a shielding body upstream of the sensor element. The shielding body is constructed and disposed with respect to the sensor element in such a way that liquid or solid particles contained in the mass flow are deflected by the shielding body into a flight path outside an area in which the sensor element is disposed. A guide body is constructed and disposed with respect to the sensor element and the shielding body in such a way that the sensor element is located outside a wind shadow of the shielding body with respect to a gaseous component of the mass flow.

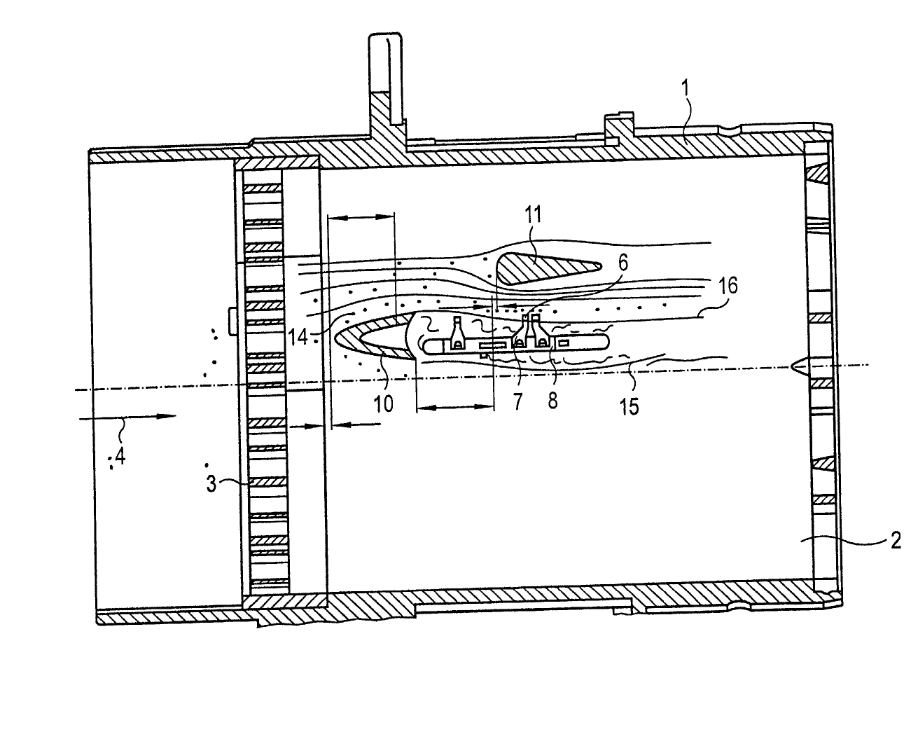

### BACKGROUND OF THE INVENTION

1. Field of the Invention

The invention relates to a mass flowmeter, in particular for detecting an air mass flow in an induction channel of an internal combustion engine.

European Patent Application 0 458 998 A1, corresponding to U.S. Pat. No. 5,253,517, discloses a mass flowmeter having a housing in which a flow channel is formed. A flow smoothing device is disposed in the housing, and a sensor element is disposed downstream of the flow smoothing device and produces a measurement signal corresponding to the air mass flow. The sensor element is in the form of a hot-film anemometer.

In mass flowmeters such as those, it is known for the hot-film resistor to be kept at a constant temperature through the use of a bridge circuit and an additional control circuit. The heating power supplied to the hot-film resistor is then a measure of the mass flow flowing over the hot-film resistor.

A mass flowmeter such as that is used, for example, in motor vehicles, where it serves to detect the air mass flow in the induction manifold of the internal combustion engine, as aspirated by the internal combustion engine. It is possible for there to be particles in the air flowing through the induction channel, depending on the respective operating conditions in which the internal combustion engine is being operated. Such particles may, for example, be water droplets. If such a water droplet strikes the surface of the sensor element, then a large amount of heating power is required to vaporize the water droplet. That leads to a considerable measurement error in the measurement signal from the sensor element.

### SUMMARY OF THE INVENTION

It is accordingly an object of the invention to provide a mass flowmeter, which overcomes the hereinafore-mentioned disadvantages of the heretofore-known devices of this general type such that it detects a mass flow reliably and precisely, even when there are particles in the mass flow.

With the foregoing and other objects in view there is provided, in accordance with the invention, a mass flowmeter, comprising a shielding body disposed upstream of a sensor element and constructed and disposed with respect to the sensor element in such a way that liquid or solid particles contained in the mass flow are deflected by the shielding body into a flight path outside an area in which the sensor element is disposed. The shielding body thus shields the sensor element from particles contained in the mass flow.

However, another major factor for reliable and precise detection of the mass flow is for there to be a stable and defined flow, preferably at a high speed and with fine vortexing of the flow, in the area of the sensor element. This ensures that the sensor element is not located in the wind shadow of the shielding body. This is achieved by providing a guide body which is constructed and disposed with respect to the sensor element and the shielding body in such a way that the sensor element is located outside a wind shadow of the shielding body with respect to the gaseous component of the mass flow. The guide body forces the gaseous component of the mass flow toward the sensor element, thus resulting in the sensor element being located in the conditioned flow. The critical effect is that the subject matter of the invention makes use of the fact that, due to their greater inertia, the particles are deflected to a considerably lesser extent by the guide body, and thus do not strike the sensor element.

Other features which are considered as characteristic for the invention are set forth in the appended claims.

Although the invention is illustrated and described herein as embodied in a mass flowmeter, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The FIGURE of the drawing is a fragmentary, diagrammatic, sectional view of a mass flowmeter according to the invention.

### DESCRIPTION OF THE PREFERRED EMBODIMENTS

Referring now in detail to the single FIGURE of the drawing, there is seen a section through a mass flowmeter which has a housing 1. A flow channel 2 is formed in the housing 1 of the mass flowmeter. A flow smoothing device 3 is disposed in the flow channel 2.

A sensor element 6, which is disposed downstream of the flow smoothing device 3 in a flow direction 4, produces a measurement signal which represents a mass flow in the flow channel. The sensor element 6 is preferably in the form of a hot-film resistor and is disposed in a bridge-circuit configuration. In this case, appropriate measures are provided to keep the temperature of the sensor element 6 constant. Electrical power which is supplied to the sensor element 6 is then a measure of the mass flow flowing past the sensor element 6. The sensor element 6 is disposed on an arm 7, which is mounted on a base body 8.

A shielding body 10 is disposed upstream of the sensor element 6. The shielding body 10 preferably has a paraboloid shape and tapers in a direction opposite to the flow direction. The resistance of the shielding body to the flow is thus low, and the flow remains well conditioned even downstream of the shielding body 10, at least outside a wind shadow of the shielding body 10.

The extent of the downstream end of the shielding body vertically with respect to the flow direction 4 is at least sufficient for it to thus correspond to an end-face height in the vertical direction with respect to the flow direction 4 of the sensor element. Furthermore, the shielding body 10 preferably has sharp edges at the downstream end, which ensure good flow separation.

A guide body 11 is constructed and disposed with respect to the sensor element 6 and the shielding body 10 in such a way that the sensor element 6 is located outside a wind shadow of the shielding body 10 with respect to a gaseous component of the mass flow.

The guide body 11 preferably has a cylindrical leading-edge surface and tapers along the flow direction 4. The cylindrical leading-edge surface ensures that the flow is deflected to a major extent. The taper of the guide body along the flow direction ensures that the flow downstream from the guide body 11 is well-conditioned. The guide body 11 has its cylindrical leading-edge surface upstream of the sensor element. This means that flow lines, in particular a flow line 16, are deflected toward the sensor element. This means that the wind shadow area of the shielding body 10, which is located between the flow line 16 and a flow line 15, is outside the area in which the sensor element 6 is disposed. The flow in the wind shadow area is undefined, has severe vortices, and is unsuitable for detection of a measurement signal.

Particles 14 contained in the mass flow are deflected by the shielding body 10 onto a flight path which is outside the area in which the sensor element 6 is disposed. Since the particles have considerably greater inertia than gaseous components of the mass flow, the particles are deflected only to an insignificant extent by the guide body 11, and can thus not strike the sensor element. In addition to the sensor element 6, other measurement sensors, for example a temperature sensor or a heating element for reverse-flow compensation, can also be disposed on the base body.

The sensor element 6 and/or the shielding body 10 and/or the guide body 11 may alternatively also be in the form of separate components, which are installed in an induction manifold of an internal combustion engine.

I claim:

1. A mass flowmeter, comprising:
a sensor element disposed in a given area;
a shielding body disposed upstream of said sensor element in a flow direction of a mass flow, said shielding body having a given wind shadow with respect to a gaseous component of the mass flow, and said shielding body having a structure and disposition relative to said sensor element for deflecting liquid or solid particles contained in the mass flow into a flight path outside said given area; and
a guide body having a structure and disposition relative to said sensor element and said shielding body for placing said sensor element outside said given wind shadow.

2. The mass flowmeter according to claim 1, wherein said shielding body has a paraboloid shape and tapers in a direction opposite to said flow direction.

3. The mass flowmeter according to claim 1, wherein said guide body has a cylindrical leading-edge surface and tapers along said flow direction.

4. The mass flowmeter according to claim 1, wherein said guide body extends upstream and downstream of said sensor element.
